(19) United States
(12) Patent Application Publication
(10) Pub. No.: US 2022/0261702 A1
(43) Pub. Date: Aug. 18, 2022

(54) INFORMATION PROCESSING DEVICE, NON-TRANSITORY STORAGE MEDIUM, AND OPERATION METHOD FOR INFORMATION PROCESSING DEVICE

(71) Applicant: TOYOTA JIDOSHA KABUSHIKI KAISHA, Toyota-shi (JP)

(72) Inventors: Yuka TAKIGUCHI, Toyota-shi (JP); Tetsushi OKAMOTO, Toyota-shi (JP); Hirokazu KOBAYASHI, Toyota-shi (JP); Minoru NAKADORI, Toyota-shi (JP); Daiki KANEICHI, Tokyo (JP)

(73) Assignee: TOYOTA JIDOSHA KABUSHIKI KAISHA, Toyota-shi (JP)

(21) Appl. No.: 17/577,756

(22) Filed: Jan. 18, 2022

(30) Foreign Application Priority Data
Feb. 18, 2021 (JP) 2021-024536

(51) Int. Cl. G06Q 10/02; G07C 5/08

(52) U.S. Cl. CPC G06Q 10/02; G07C 5/0816

(57) ABSTRACT

An information processing device includes a controller configured to send information to another device and receive information from the other device. The controller is configured to select an available model based on a reservation status for each model of vehicles stored at a first storage location, the available model being a model with a longer available time than other models. The controller is configured to send, to a first vehicle of the available model, a command to move to an on-demand waiting area.

### CROSS-REFERENCE TO RELATED APPLICATION

This application claims priority to Japanese Patent Application No. 2021-024536 filed on Feb. 18, 2021, incorporated herein by reference in its entirety.

### BACKGROUND

### 1. Technical Field

The present disclosure relates to information processing devices, non-transitory storage media, and operation methods for the information processing device.

### 2. Description of Related Art

As car sharing services are becoming more widespread, various technologies for managing vehicles that are used for the car sharing services have been proposed.

For example, Japanese Unexamined Patent Application Publication No. 2017-102553 (JP 2017-102553 A) discloses a vehicle management system capable of rationally sharing vehicles between a car sharing service and a car rental service by combining vehicle management for the car sharing service and vehicle management for the car rental service.

### SUMMARY

There is room for improvement in a vehicle management method for on-demand use in which a user requests a shared car waiting in a waiting location and uses it on the spot.

The present disclosure provides an information processing device, a non-transitory storage medium, and an operation method for the information processing device that improve the efficiency of management of vehicles that are provided for on-demand use in a car sharing service.

A first aspect of the present disclosure is an information processing device. The information processing device includes a controller configured to send and receive information to another device and receive information from the other device. The controller is configured to select an available model based on a reservation status for each model of vehicles stored at a first storage location, the available model being a model with a longer available time than other models. The controller is also configured to send a command to a first vehicle of the available model to move to an on-demand waiting area.

In the first aspect, the controller may be configured to select the available model on an additional condition that the number of vehicles about this model stored at the first storage location is larger than the number of vehicles about the other models stored at the first storage location.

In the first aspect, the controller may be configured to select the available model on an additional condition that a preset downtime of the available model necessary to prepare for use is shorter than preset downtimes of the other models.

In the first aspect, the controller may be configured to select the available model in predetermined order of priority.

In the first aspect, the controller may be configured to select the first vehicle on an additional condition that an available time of the first vehicle is equal to or longer than a reference time.

In the first aspect, the controller may be configured to select the first vehicle on an additional condition that elapsed time since previous use of the first vehicle is longer than elapsed times since previous use of other vehicles corresponding to the available model.

In the first aspect, the controller may be configured to, when the controller does not select the first vehicle, send the command to a second vehicle instead of the first vehicle, the second vehicle being a vehicle that is stored at a second storage location and belongs to the available model and elapsed time since previous use of the second vehicle being equal to or longer than the reference time.

In the first aspect, the controller may be configured to stop sending the command when the controller does not select the second vehicle.

In the first aspect, the controller may be configured to perform a process of sending the command to the first vehicle corresponding to the available model by selecting the available model stored at the first storage location at a predetermined timing after stopping sending the command.

In the first aspect, the information processing device may include a transmitter. The controller may be configured to send information to the other device via the transmitter and receive information from the other device via the transmitter.

A second aspect of the present disclosure is a non-transitory storage medium storing instructions that are executable by one or more processors in an information processing device, and that cause the one or more processors in the information processing device to perform functions. The functions include: sending information to another device; receiving information from the other device; selecting an available model based on a reservation status for each model of vehicles stored at a first storage location, the available model being a model with a longer available time than other models; and sending a command to a first vehicle of the available model to move to an on-demand waiting area.

A third aspect of the present disclosure is an operation method for an information processing device including a controller configured to send information to another device and receive information from the other device. The operation method includes: selecting an available model by the controller based on a reservation status for each model of a plurality of vehicles stored at a first storage location, the available model being a model with a longer available time than other models; and sending a command from the controller to a first vehicle of the available model to move to an on-demand waiting area.

In the third aspect, the operation method may further include selecting the available model by the controller on an additional condition that the number of vehicles about this model stored at the first storage location is larger than the number of vehicles about the other models stored at the first storage location.

In the third aspect, the operation method may further include selecting the available model by the controller on an additional condition that a preset downtime of the available model necessary to prepare for use is shorter than preset downtimes of the other models.

In the third aspect, the operation method may further include selecting the available model by the controller in predetermined order of priority.

In the third aspect, the operation method may further include selecting the first vehicle by the controller on an additional condition that an available time of the first vehicle is equal to or longer than a reference time.

In the third aspect, the operation method may further include selecting the first vehicle by the controller on an additional condition that elapsed time since previous use of the first vehicle is longer than elapsed times since previous use of other vehicles corresponding to the available model.

In the third aspect, the operation method may further include, when the first vehicle is not selected by the controller, sending the command from the controller to a second vehicle instead of the first vehicle, the second vehicle being a vehicle that is stored at a second storage location and belongs to the available model and elapsed time since previous use of the second vehicle being equal to or longer than the reference time.

In the third aspect, the operation method may further include stopping sending the command from the controller when the second vehicle is not selected by the controller.

In the third aspect, the operation method may further include performing a process of sending the command from the controller to the first vehicle corresponding to the available model by selecting the available model stored at the first storage location at a predetermined timing after stopping sending the command.

According to the first, second, and third aspects of the present disclosure, it is possible to improve the efficiency of management of vehicles that are provided for on-demand use in a car sharing service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a configuration of an information processing system;

FIG. 2 shows an example of parking areas;

FIG. 3 is a block diagram showing a configuration of an information processing device;

FIG. 4 is a block diagram showing a configuration of a terminal device;

FIG. 5 is a block diagram showing a configuration of a vehicle;

FIG. 6 is a flowchart showing an example of an operation procedure of the information processing device for reservation use;

FIG. 7 is a flowchart showing an example of an operation procedure of the information processing device for on-demand use;

FIG. 8 shows an example of replenishment with a vehicle that is provided for on-demand use;

FIG. 9 is a flowchart showing an example of an operation procedure that is performed by the information processing device when replenishing with a vehicle that is provided for on-demand use;

FIG. 10 is a flowchart showing an example of an operation procedure that is performed by the information processing device when selecting an available model and a vehicle;

FIG. 11 is an example of a reservation table showing the reservation status of models and vehicles;

FIG. 12 is an example of a reservation table showing the reservation status of models and vehicles;

FIG. 13 is an example of a reservation table showing the reservation status of models and vehicles;

FIG. 14 is an example of a reservation table showing the reservation status of a model and vehicles; and

FIG. 15 is an example of a reservation table showing the reservation status of a model and vehicles.

### DETAILED DESCRIPTION OF EMBODIMENTS

Hereinafter, an embodiment of the present disclosure will be described below with reference to the drawings.

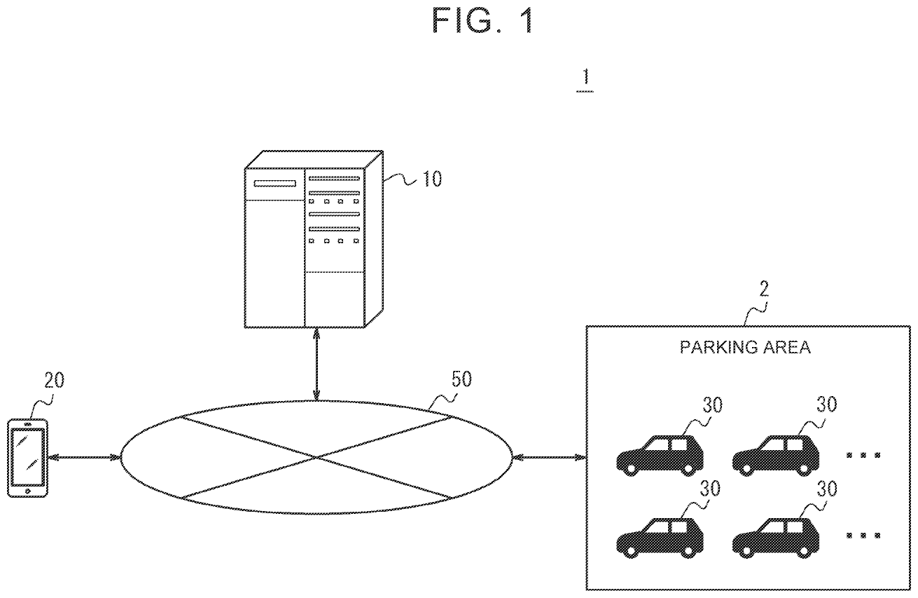

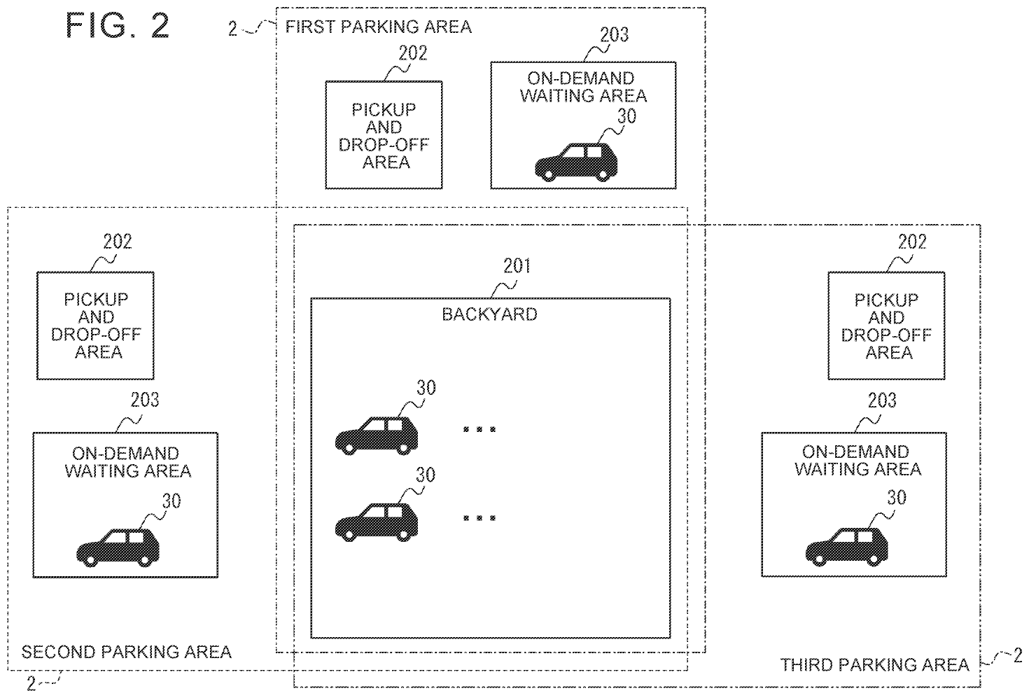

FIG. 1 shows a configuration of an information processing system 1 according to an embodiment. The information processing system 1 is a system that provides a car sharing service to users by using a vehicle 30. FIG. 2 illustrates parking areas 2 in which the vehicle 30 is stored or wait. The configuration and overview of the information processing system 1 will be described with reference to FIGS. 1 and 2.

The information processing system 1 includes one or more information processing devices 10, one or more terminal devices 20, and one or more vehicles 30. The one or more information processing devices 10, the one or more terminal devices 20, and the one or more vehicles 30 are connected to each other via a network 50 so that they can communicate with each other.

The information processing device 10 is, for example, a computer configured to function as a server, such as a general-purpose personal computer (personal computer). The information processing device 10 monitors the status of the vehicle 30 in the parking area 2 based on, for example, data acquired from a camera, sensor, etc. installed in the parking area 2. The information processing device 10 communicates with the terminal device 20 and the vehicle 30 via the network 50, and manages the vehicle 30 that is used for the car sharing service.

The terminal device 20 is a terminal device that is used by a user who uses the car sharing service. The terminal device 20 is, for example, a smartphone or a tablet.

The vehicle 30 is a vehicle that is used for the car sharing service. For example, the vehicle 30 is any type of automobile such as gasoline vehicle, diesel vehicle, hybrid vehicle (HV), plug-in hybrid vehicle (PHV), electric vehicle (EV), or fuel cell vehicle (FCV). HV may be called a hybrid electric vehicle (HEV). PHV may be called a plug-in hybrid electric vehicle (PHEV). EV may be called a battery electric vehicle (BEV). FCV may be called a fuel cell electric vehicle (FCEV). The vehicle 30 is a vehicle capable of autonomous driving and having, for example, an automated valet parking (AVP) function. For example, when the user uses the car sharing service, the vehicle 30 can autonomously move to a place where the user picks up the vehicle 30. When the user drops off the vehicle 30, the vehicle 30 can autonomously move to a predetermined position.

The network 50 is a network including, for example, a mobile communication network and the Internet.

FIG. 2 shows an example of three parking areas 2, namely first to third parking areas 2 (hereinafter referred to as the parking areas 2 when the first to third parking areas need not be identified). The parking area 2 is a space where the vehicle 30 not being used by the user is stored or waits. For example, the parking area 2 is provided in the basement of an apartment building where the user of the car sharing service etc. lives. A plurality of parking areas 2 may overlap each other as shown in the figure, or may be located separately from each other. The parking areas 2 need not necessarily be provided in the basement of the same apartment building. The parking areas 2 may be dispersed in the basements of different apartment buildings or may be provided in sites located about several tens to several hundreds of meters away from each other. Each parking area 2 has one or more backyards 201, one or more pickup and drop-off areas 202, and one or more on-demand waiting areas 203 in a desired layout. Each parking area 2 may have its own backyard 201, pickup and drop-off area 202, and on-demand waiting area 203, or two or more parking areas 2 may share one or more of the following areas: the backyard 201, the pickup and drop-off area 202, and the on-demand waiting area 203. In the example described herein, the three parking areas 2 share the backyard 201, and each of the three parking areas 2 has its own pickup and drop-off area 202 and on-demand waiting area 203.

In the car sharing service provided by the information processing system 1, the user can use the vehicle 30 for both reservation use and on-demand use. Reservation use is the type of use in which the user makes an advance reservation to use the vehicle 30 stored in a storage location in the parking area 2, namely in the backyard 201. The backyard 201 has equipment for servicing the vehicle 30 stored in the backyard 201, such as equipment for charging the battery of the vehicle 30 and equipment for cleaning the vehicle 30. The pickup and drop-off area 202 is a space where the user picks up and drops off the vehicle 30 for reservation use. On-demand use is the type of use in which the user goes to the waiting location in the parking area 2 where the vehicle 30 for on-demand use waits, namely the user goes to the on-demand waiting area 203, and then requests the vehicle 30 waiting in the on-demand waiting area 203 and uses the vehicle 30 immediately.

The information processing device 10 manages one or more models of one or more vehicles 30 stored or waiting in each parking area 2. By managing one or more models and one or more vehicles 30 of each model, the information processing device 10 can provide the user with the vehicle 30 of the model that matches the user's purpose by either reservation use or on-demand use. The vehicle 30 is not exclusively used for reservation use or on-demand use. The vehicle 30 is dynamically assigned to reservation use or on-demand use by the information processing device 10. For example, the information processing device 10 assigns the vehicle 30 not reserved for reservation use to on-demand use and sends a command to that vehicle 30 to move from the backyard 201 to the on-demand waiting area 203, or assigns the vehicle 30 not being used for on-demand use to reservation use and sends a command to that vehicle 30 to move from the on-demand waiting area 203 to the backyard 201.

In the present embodiment, the information processing device 10 selects the model with a longer available time than the other models (hereinafter referred to as the available model) based on the reservation status of each model of a plurality of vehicles 30 stored in the storage location in the parking area 2, that is, the backyard 201. The information processing device 10 then sends a command to the vehicle 30 of the available model to move to the waiting location for on-demand use in the parking area 2, that is, the on-demand waiting area 203. The information processing device 10 can thus optimally allocate a limited number of vehicles 30 in the parking area 2 to reservation use or on-demand use and reliably secure the vehicle 30 that is provided for on-demand use. It is therefore possible to improve the efficiency of management of the vehicles 30 that are provided for on-demand use.

When the user uses the car sharing service by reservation use or on-demand use, the following operation is generally performed.

For reservation use, the user uses the terminal device 20 to send request information for reservation use to the information processing device 10. The request information includes information on a desired model, pickup date and time, scheduled return date and time, and desired pickup location. The user designates a desired location such as the pickup and drop-off area 202 or in front of the user's residence as the pickup location. The information processing device 10 dispatches the vehicle 30 assigned to the reservation use so that the vehicle 30 of the model desired by the user arrives at the pickup location designated by the user at least a predetermined time before the pickup date and time. The vehicle 30 autonomously heads for the pickup location designated by the user in response to a command received from the information processing device 10.

For on-demand use, the user goes to the on-demand waiting area 203, and when there is any vehicle 30 waiting in the on-demand waiting area 203, the user requests on-demand use of that vehicle 30. The user operates the terminal device 20 to send request information for on-demand use to the information processing device 10. The request information includes information on a scheduled return date and time. For on-demand use, the user uses the vehicle 30 waiting in the on-demand waiting area 203 without selecting in advance the model and the pickup location. Information on a pickup date and time is therefore not necessary. A two-dimensional code including information necessary to request on-demand use is attached to the vehicle 30. The user uses the terminal device 20 to take a picture of the two-dimensional code attached to the vehicle 30 waiting in the on-demand waiting area 203. The terminal device 20 sends information included in the two-dimensional code to the information processing device 10. The two-dimensional code includes, for example, identification information identifying the vehicle 30. The information processing device 10 thus identifies and manages the vehicle 30 to be used for on-demand use.

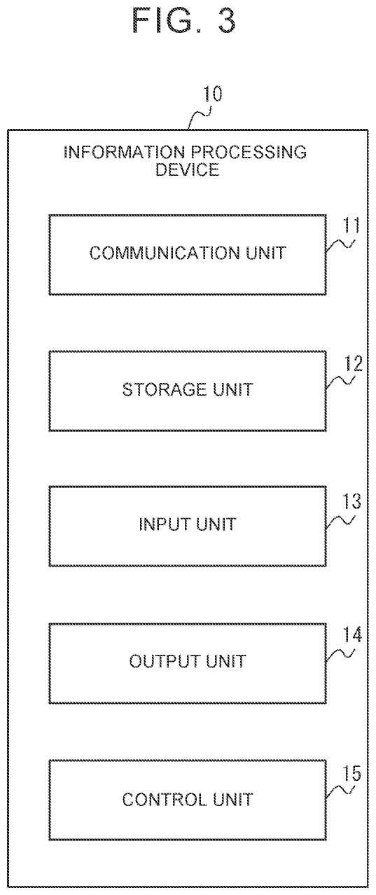

The configuration of the information processing device 10 according to the present embodiment will be described with reference to FIG. 3.

The information processing device 10 includes a communication unit 11, a storage unit 12, an input unit 13, an output unit 14, and a control unit 15.

The communication unit 11 includes a communication module connected to the network 50. For example, the communication unit 11 may include a communication module compatible with a local area network (LAN). In the present embodiment, the information processing device 10 is connected to the network 50 via the communication unit 11. The communication unit 11 sends and receives various kinds of information via the network 50. The communication unit 11 can communicate with the terminal device 20 and the vehicle 30 via the network 50.

For example, the storage unit 12 is, but not limited to, a semiconductor memory, a magnetic memory, or an optical memory. The storage unit 12 may function as, for example, a main storage device, an auxiliary storage device, or a cache memory. The storage unit 12 stores any information to be used for the operation of the information processing device 10. For example, the storage unit 12 may store a system program, an application program, and various kinds of information received by the communication unit 11. The information stored in the storage unit 12 may be updatable with, for example, information received from the network 50 via the communication unit 11. A part of the storage unit 12 may be installed outside the information processing device 10. In that case, the part of the storage unit 12 installed outside the information processing device 10 is connected to the information processing device 10 via, for example, a desired interface.

The input unit 13 includes one or more input interfaces that detect user input and acquire input information based on the user's operation. For example, the input unit 13 includes, but not limited to, a physical key, a capacitive key, a touch screen integrated with a display of the output unit 14, or a microphone that accepts voice input.

The output unit 14 includes one or more output interfaces that output information to notify the user. For example, the output unit 14 includes, but not limited to, a display that outputs information as images or a speaker that outputs information as audio.

The control unit 15 includes one or more processors, one or more dedicated circuits, or a combination thereof. The processor is a general-purpose processor such as central processing unit (CPU) or graphics processing unit (GPU), or a dedicated processor specialized for a specific process. The dedicated circuit is, for example, a field-programmable gate array (FPGA) or an application-specific integrated circuit (ASIC). The control unit 15 performs processes related to the operation of the information processing device 10 while controlling each unit of the information processing device 10.

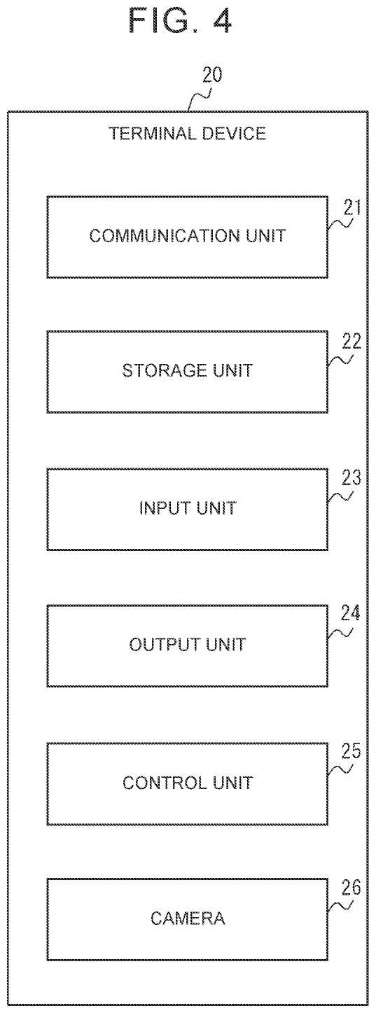

The configuration of the terminal device 20 according to the present embodiment will be described with reference to FIG. 4.

The terminal device 20 includes a communication unit 21, a storage unit 22, an input unit 23, an output unit 24, a control unit 25, and a camera 26.

The communication unit 21 includes a communication module connected to the network 50. For example, the communication unit 21 may include a communication module compatible with mobile communication standards such as Long-Term Evolution (LTE), 4th generation (4G), and 5th generation (5G). In the present embodiment, the terminal device 20 is connected to the network 50 via the communication unit 21. The communication unit 21 sends and receives various kinds of information via the network 50. The communication unit 21 can communicate with the information processing device 10 and the vehicle 30 via the network 50.

For example, the storage unit 22 is, but not limited to, a semiconductor memory, a magnetic memory, or an optical memory. The storage unit 22 may function as, for example, a main storage device, an auxiliary storage device, or a cache memory. The storage unit 22 stores any information to be used for the operation of the terminal device 20. For example, the storage unit 22 may store a system program, an application program, and various kinds of information received by the communication unit 21. The information stored in the storage unit 22 may be updatable with, for example, information received from the network 50 via the communication unit 21. A part of the storage unit 22 may be installed outside the terminal device 20. In that case, the part of the storage unit 22 installed outside the terminal device 20 may be connected to the terminal device 20 via a desired interface.

The input unit 23 includes one or more input interfaces that detect user input and acquire input information based on the user's operation. For example, the input unit 23 includes, but not limited to, a physical key, a capacitive key, a touch screen integrated with a display of the output unit 24, or a microphone that accepts voice input.

The output unit 24 includes one or more output interfaces that output information to notify the user. For example, the output unit 24 includes, but not limited to, a display that outputs information as images or a speaker that outputs information as audio.

The control unit 25 includes one or more processors, one or more dedicated circuits, or a combination thereof. The processor is a general-purpose processor such as CPU or GPU, or a dedicated processor specialized for a specific process. The dedicated circuit is, for example, an FPGA or an ASIC. The control unit 25 performs processes related to the operation of the terminal device 20 while controlling each unit of the terminal device 20.

The camera 26 is a camera capable of capturing images.

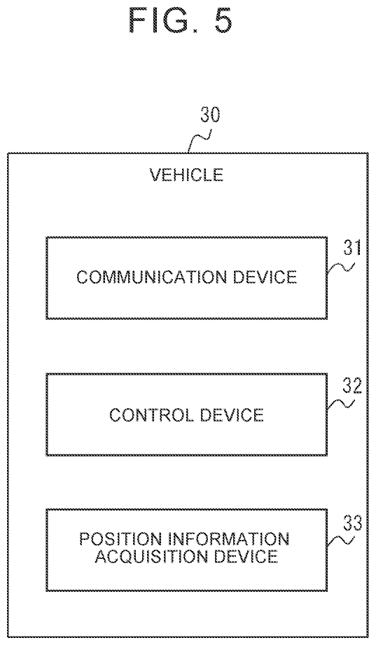

The configuration of the vehicle 30 according to the present embodiment will be described with reference to FIG. 5.

The vehicle 30 includes a communication device 31, a control device 32, and a position information acquisition device 33. The communication device 31, the control device 32, and the position information acquisition device 33 are connected to each other via an in-vehicle network such as Controller Area Network (CAN) or a dedicated line so that they can communicate with each other.

The communication device 31 includes a communication module connected to the network 50. For example, the communication device 31 may include a communication module compatible with mobile communication standards such as LTE, 4G, and 5G. In the present embodiment, the vehicle 30 is connected to the network 50 via the communication device 31. The communication device 31 sends and receives various kinds of information via the network 50. The communication device 31 can communicate with the information processing device 10 and the terminal device 20 via the network 50.

The control device 32 includes one or more processors, one or more dedicated circuits, or a combination thereof. The processor is a general-purpose processor such as CPU or GPU, or a dedicated processor specialized for a specific process. The dedicated circuit is, for example, an FPGA or an ASIC. The control device 32 performs processes related to the operation of the vehicle 30 while controlling each unit of the vehicle 30.

The position information acquisition device 33 includes one or more receivers compatible with a desired satellite positioning system. For example, the position information acquisition device 33 may include a Global Positioning System (GPS) receiver. The position information acquisition device 33 acquires a measured value of the position of the vehicle 30 as position information. The position information includes, for example, an address, latitude, longitude, and altitude.

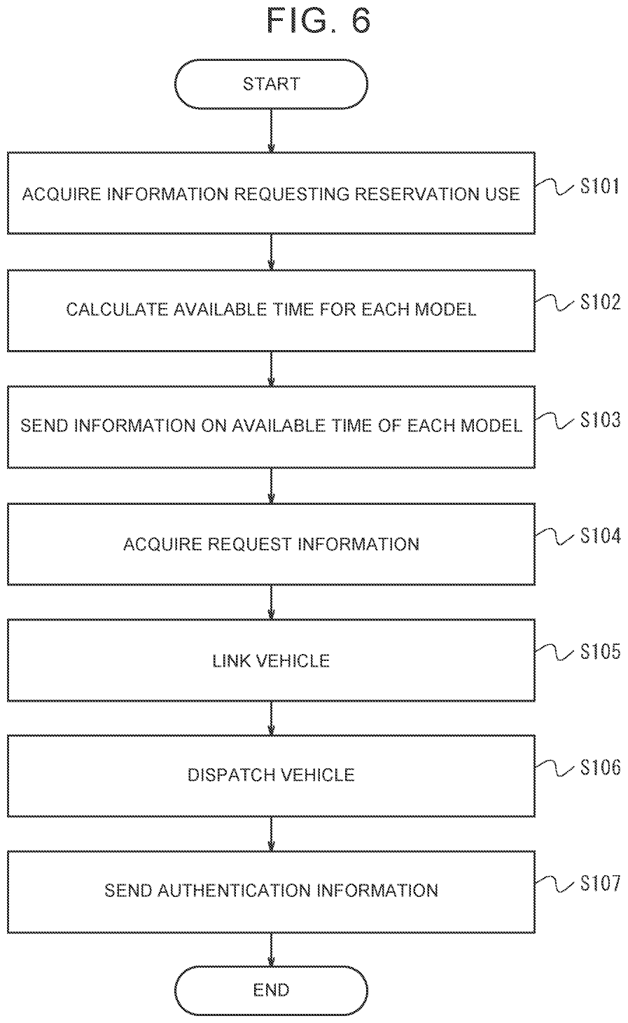

The information processing device 10 configured as described above manages the vehicles 30 by acquiring information identifying the model and vehicle body of the vehicle 30 and position information of the vehicle 30 from the vehicle 30 at a desired timing and dynamically assigning each vehicle 30 to reservation use or on-demand use. For example, the control unit 15 of the information processing device 10 manages information, such as the distribution status of the vehicles 30 in the backyard 201 and each on-demand waiting area 203, the model of each vehicle 30 in the backyard 201 and each on-demand waiting area 203, and the reservation status for each model, by storing this information in the storage unit 12 and updating this information as necessary. The operation for such management will be described in detail with reference to FIGS. 6 to 15.

FIG. 6 is a flowchart showing an example of an operation procedure of the information processing device 10 when managing reservation use. The procedure of FIG. 6 is performed when the input unit 23 of the terminal device 20 accepts an input requesting reservation use from the user who desires reservation use and the control unit 25 of the terminal device 20 sends information requesting reservation use to the information processing device 10 via the communication unit 21.

The control unit 15 of the information processing device 10 acquires via the communication unit 11 the information requesting reservation use sent from the terminal device 20 (step S101).

The control unit 15 calculates an available time for each model of the vehicles 30 (step S102). The available time is the maximum time for which the vehicle 30 of each model is available. The control unit 15 calculates the available time by subtracting a lead time and a downtime from the time available until the next reservation of the vehicle 30. The lead time is the amount of time set as an estimated time required to dispatch the reserved vehicle 30 to the pickup location desired by the user. The lead time is, for example, 30 minutes. The downtime is the amount of time set as a service unavailable time until the vehicle 30 becomes available to the next user after one user uses that vehicle 30. Specifically, the downtime is the amount of time set as desired in view of the time required to charge the vehicle 30, the time required to clean the vehicle 30, the time required to inspect the vehicle 30, etc. The downtime may be different for each model. The control unit 15 calculates the available pickup date and time of the vehicle 30 for reservation use, namely the date and time when the vehicle 30 will become available for reservation use, as the lead time from the current time. When the available time is longer than an upper limit (e.g., one week or two weeks) set as desired, the control unit 15 may set the available time to the value of the upper limit of the available time. The control unit 15 calculates the available time for each model. When there is more than one available vehicle 30 of the same model, the control unit 15 calculates the available time of each of those available vehicles 30 and selects the longest one of the calculated available times as the available time of that model.

The control unit 15 sends information on the available time of each model to the terminal device 20 via the communication unit 11 (step S103).

When the control unit 25 of the terminal device 20 acquires the information on the available time of each model, the control unit 25 causes the output unit 24 to display the information on the available time of each model.

After checking the information on the available time of each model, the user enters request information for reservation use of the vehicle 30 to the input unit 23 of the terminal device 20. The user enters, for example, information on the model, pickup date and time, scheduled return date and time, and pickup location. The control unit 25 sends the request information entered by the user to the information processing device 10 via the communication unit 21.

The control unit 15 of the information processing device 10 acquires via the communication unit 11 the request information sent from the terminal device 20 (step S104).

The control unit 15 links the vehicle 30 to the acquired request information (step S105). As used herein, linking the vehicle 30 means identifying the vehicle 30 to be used for reservation use based on the acquired required information. Linking of the vehicle 30 will be described in detail later.

The control unit 15 dispatches the vehicle 30 so that the vehicle 30 will arrive at the desired pickup location at least a predetermined time before the pickup date and time (step S106). The predetermined time is, for example, 10 minutes. For example, when the pickup date and time is 10:00 on January 1st and the predetermined time is 10 minutes, the control unit 15 dispatches the vehicle 30 so that the vehicle 30 will arrive at the desired pickup location by 9:50 on January 1st. When the vehicle 30 receives a dispatch command from the control unit 15, the vehicle 30 autonomously heads for the pickup location desired by the user.

The control unit 15 sends authentication information for the user to pick up the dispatched vehicle 30 to the terminal device 20 via the communication unit 11 (step S107).

The user can start using the vehicle 30 by going to the desired pickup location at the pickup date and time and performing an authentication process for the vehicle 30 parked at the pickup location using the authentication information acquired by the terminal device 20.

The user who has finished using the vehicle 30 drops off the vehicle 30 at a desired location. For example, the user may drop off the vehicle 30 either in the pickup and drop-off area 202 of the parking area 2 or at other location. After the user drops off the vehicle 30, the vehicle 30 autonomously returns to the backyard 201 of the parking area 2.

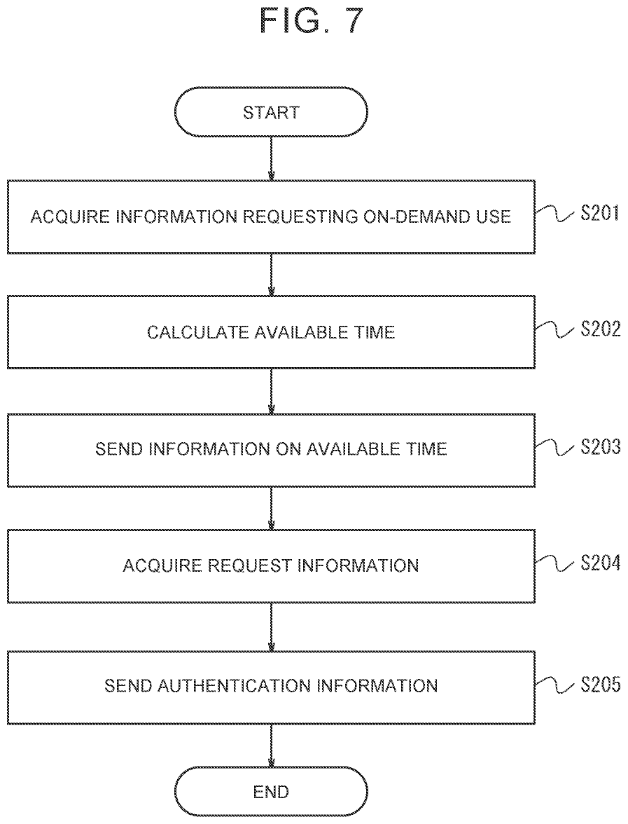

FIG. 7 is a flowchart showing an example of an operation procedure of the information processing device 10 when managing on-demand use. The procedure of FIG. 7 is performed when the user who desires on-demand use goes to the on-demand waiting area 203 in any parking area 2 and takes a picture of the two-dimensional code attached to the vehicle 30 waiting in the on-demand waiting area 203 by the camera 26 of the terminal device 20 and the control unit 25 sends information included in the two-dimensional code to the information processing device 10 via the communication unit 21.

The control unit 15 of the information processing device 10 acquires via the communication unit 11 information requesting on-demand use sent from the terminal device 20 (step S201).

The control unit 15 calculates the available time of the vehicle 30 (step S202). The available time of the vehicle 30 is calculated by the control unit 15 and the terminal device 20 takes a picture of a two-dimensional code. The control unit 15 calculates the available time by subtracting the downtime from the time available until the next reservation of the vehicle 30. The control unit 15 calculates the available pickup date and time of the vehicle 30 for on-demand use, namely the date and time when the vehicle 30 will become available for on-demand use, as the current time. When the control unit 15 calculates the available time for on-demand use and the calculated available time is longer than an upper limit (e.g., 12 hours) set as desired, the control unit 15 may set the available time to the value of the upper limit of the available time.

The control unit 15 sends information on the calculated available time to the terminal device 20 via the communication unit 11 (step S203).

When the control unit 25 of the terminal device 20 acquires the information on the available time of the vehicle 30 parked in the on-demand waiting area 203, the control unit 25 causes the output unit 24 to display the information on the available time.

After checking the information on the available time of the vehicle 30 parked in the on-demand waiting area 203, the user enters request information for on-demand use of the vehicle 30 to the input unit 23 of the terminal device 20. The output unit 24 displays a predetermined display when the user enters the request information. The user enters information on scheduled return date and time. The control unit 25 sends the request information entered by the user to the information processing device 10 via the communication unit 21.

The control unit 15 of the information processing device 10 acquires via the communication unit 11 the request information sent from the terminal device 20 (step S204).

The control unit 15 sends authentication information for the user to pick up the vehicle 30 parked in the on-demand waiting area 203 to the terminal device 20 via the communication unit 11 (step S205).

The user starts using the vehicle 30 by performing an authentication process for the vehicle 30 parked in the on-demand waiting area 203 using the authentication information acquired by the terminal device 20.

The user who has finished using the vehicle 30 drops off the vehicle 30 at a desired location. For example, the user may drop off the vehicle 30 either in the pickup and drop-off area 202 of the parking area 2 or at other location. After the user drops off the vehicle 30, the vehicle 30 autonomously returns to the backyard 201 of the parking area 2.

The information processing device 10 manages reservation use and on-demand use according to the procedures shown in FIGS. 6 and 7. The number of vehicles 30 that should wait in the on-demand waiting area 203 is set as desired in advance so as to maximize the opportunity profit. However, when one or more vehicles 30 are provided for on-demand use, the on-demand waiting area 203 will become short of an available vehicle(s) 30 accordingly. Therefore, in order to minimize the opportunity cost due to the shortage of the vehicle(s) 30, the information processing device 10 replenishes with the vehicle 30 to be provided for on-demand use.

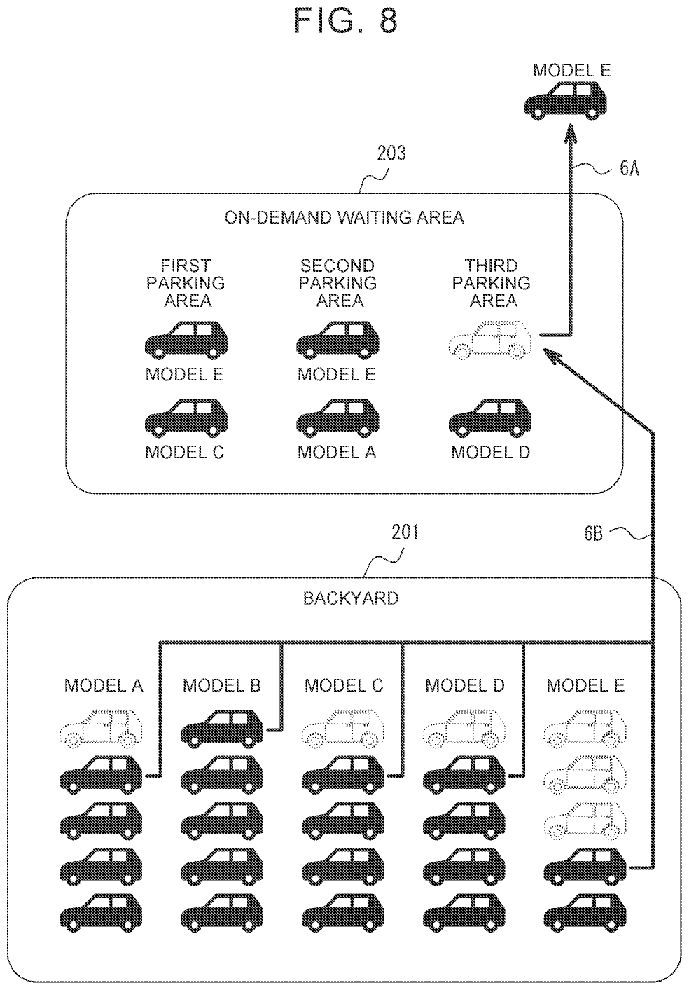

FIG. 8 schematically illustrates the operation of replenishing with the vehicle 30 to be provided for on-demand use by the information processing device 10. FIG. 8 shows the parking areas 2 of FIG. 2 as an example. Specifically, FIG. 8 shows the wait status of the vehicles 30 in the on-demand waiting area 203 in each of the first to third parking areas 2 and the storage status of the vehicles 30 in the backyard 201. For example, in the first to third parking areas 2, a total of 25 vehicles 30, five for each model A, B, C, D, and E, are distributed to the on-demand waiting areas 203 and the backyard 201. For example, the first to third parking areas 2 are configured so that a total of six vehicles 30 wait in the on-demand waiting areas 203 of the first to third parking area 2, two in each on-demand waiting area 203. FIG. 8 shows a situation in which one vehicle 30 of model E is in on-demand use (arrow 6A). Specifically, one vehicle 30 of model C and one vehicle 30 of model E were waiting in the on-demand waiting area 203 of the first parking area 2, one vehicle 30 of model A and one vehicle 30 of model E were waiting in the on-demand waiting area 203 of the second parking area 2, and one vehicle 30 of model D and one vehicle 30 of model E were waiting in the on-demand waiting area 203 of the third parking area 2, and therefore the on-demand waiting area 203 of the third parking area 2 is short of one vehicle 30. A total of 19 vehicles 30, four of model A, five of model B, four of model C, four of model D, and two of model E, are stored in the backyard 201. In order to replenish the on-demand waiting area 203 of the third parking area 2 with a vehicle 30 of model E, the information processing device 10 assigns one vehicle 30 of model E stored in the backyard 201 to on-demand use as appropriate, and sends a command to that vehicle 30 to move to the on-demand waiting area 203 of the third parking area 2 (arrow 6B).

In each parking area 2, such replenishment is made by moving a vehicle 30 from the backyard 201 of that parking area 2 to the on-demand waiting area 203 of that parking area 2. The replenishment may be made with a vehicle 30 stored in the backyard 201 of a different parking area 2. In the present embodiment, since the first to third parking areas 2 share the backyard 201, the on-demand waiting area 203 of each parking area 2 is replenished with a vehicle 30 stored in the common backyard 201.

Since the vehicles 30 stored in the backyard 201 are provided for reservation use, it is desirable to make such replenishment for on-demand use while not hindering dispatching of the vehicles 30 for reservation use. Accordingly, the information processing device 10 determines the model and the vehicle 30 to be moved to the on-demand waiting area 203 for replenishment according to the reservation status of the models stored in the backyard 201. This operation procedure will be described below.

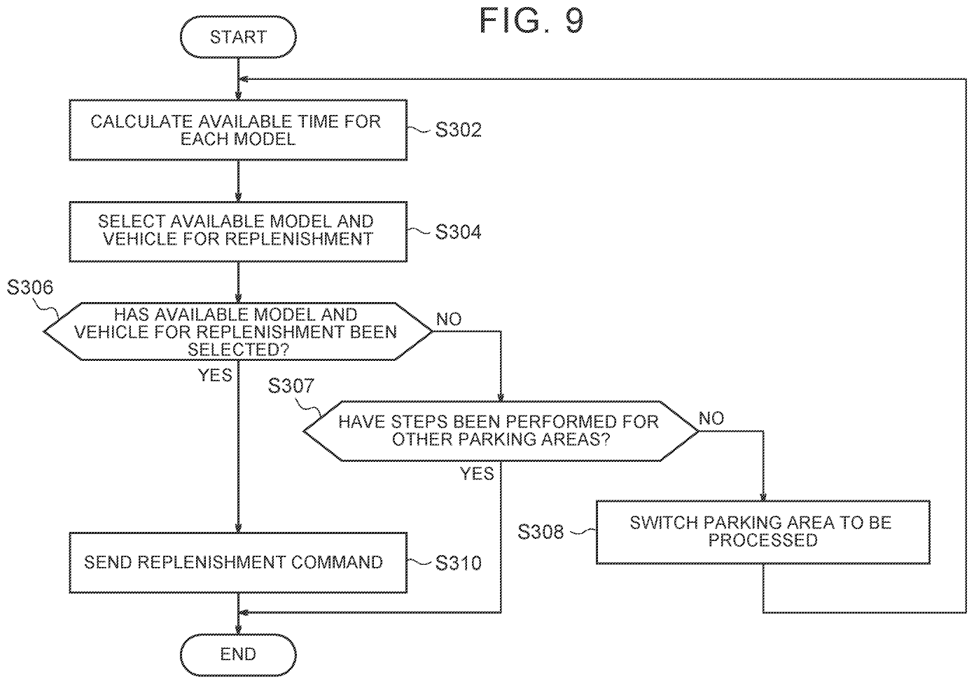

FIG. 9 is a flowchart showing an example of an operation procedure that is performed when the information processing device 10 replenishes with a vehicle 30 to be provided for on-demand use. The procedure of FIG. 9 is performed when the vehicle 30 is in on-demand use by the user and the on-demand waiting area 203 becomes short of a vehicle 30, that is, after step S205 of FIG. 7. For example, the control unit 15 performs the procedure of FIG. 9 when it confirms from the position information received from the vehicle 30 that the vehicle 30 has left the on-demand waiting area 203 for on-demand use based on the authentication information sent in step S205. The procedure of FIG. 9 is performed every time the on-demand waiting area 203 becomes short of one vehicle 30. Specifically, the procedure of FIG. 9 is performed for the vehicle 30 stored in the backyard 201 of the parking area 2 to which the on-demand waiting area 203 short of one vehicle 30 belongs.

The control unit 15 calculates the available time for each model of the vehicles 30 stored in the backyard 201 based on the reservation status (step S302). The available time is the amount of time for which the model stored for reservation use is available when assigned to on-demand use, and is the longest of the available times of the vehicles 30 of each model. The control unit 15 calculates the available time by subtracting a lead time and a downtime from the time available until the next reservation of the vehicle 30. The lead time is the amount of time set as an estimated time required for the vehicle 30 to move from the backyard 201 to the on-demand waiting area 203. The lead time varies according to the distance between the backyard 201 and the on-demand waiting area 203 and is, for example, a few minutes to 30 minutes. The downtime is the amount of time set as a service unavailable time until the vehicle 30 becomes available to the next user after one user uses the vehicle 30. Specifically, the downtime is the amount of time set as desired in view of the time required to charge the vehicle 30, the time required to clean the vehicle 30, the time required to inspect the vehicle 30, etc. The downtime may be different for each model. The control unit 15 calculates the available pickup date and time of the vehicle 30 for on-demand use, namely the date and time when the vehicle 30 will become available for on-demand use, as the lead time from the current time. When the available time is longer than an upper limit (e.g., 12 hours) set as desired, the control unit 15 may set the available time to the value of the upper limit of the available time. The control unit 15 calculates the available time for each model. When there is more than one available vehicle 30 of the same model, the control unit 15 calculates the available time of each of those available vehicles 30 and selects the longest of the calculated available times as the available time of that model.

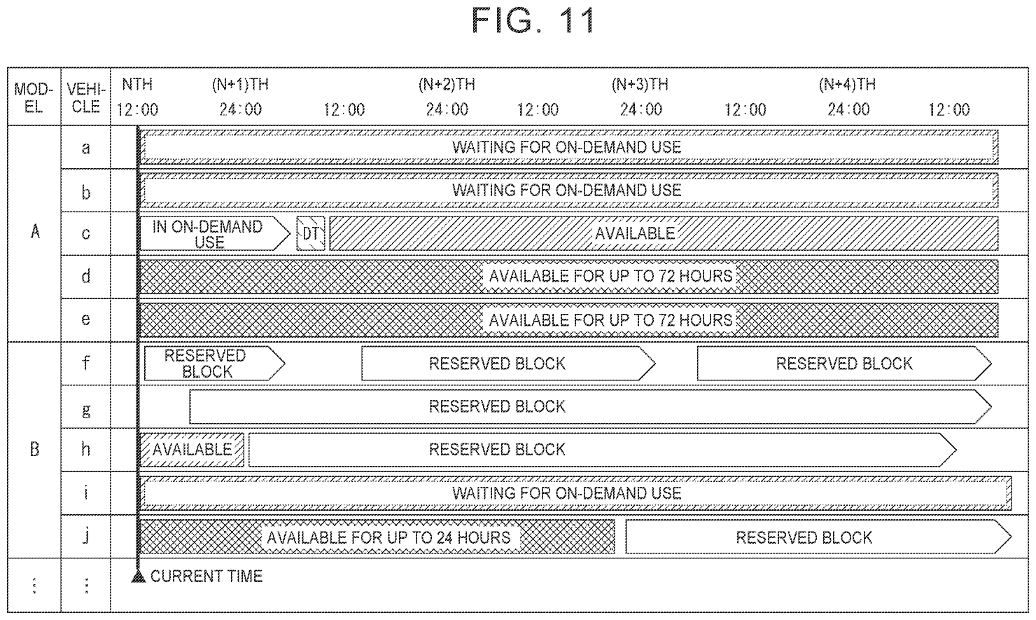

FIG. 11 shows an example of a reservation table for the control unit 15 to manage the vehicles 30. This reservation table shows the reservation status of five vehicles 30 of each model A, B, namely, the reservation status of vehicles a, b, c, d, and e of model A and vehicles f, g, h, i, and j of model B. In this reservation table, the abscissa represents time. For example, the vehicles a, b, and c of model A and the vehicle i of model B are currently provided for on-demand use. The vehicles a, b, and i are waiting for on-demand use, and the vehicle c is in on-demand use. The vehicle c is scheduled to be used until the next day and will then become available after the downtime DT. The vehicles d and e of model A are currently available and can be used for up to 72 hours from the current time. The vehicle f of model B has been reserved intermittently and continually, and this status is shown by reserved blocks. The vehicles g and h of model B have been reserved from afternoon and midnight of the same day, respectively. The vehicle j of model B is currently available and can be used for up to 24 hours from the current time. The vehicle j has been reserved after that. In this situation, the control unit 15 selects the available time of the vehicle d or e, namely 72 hours, as the available time of model A, and selects the available time of the vehicle j, namely 24 hours, as the available time of model B.

Returning back to FIG. 9, the control unit 15 then selects the available model and the vehicle 30 of the available model for replenishment (step S304).

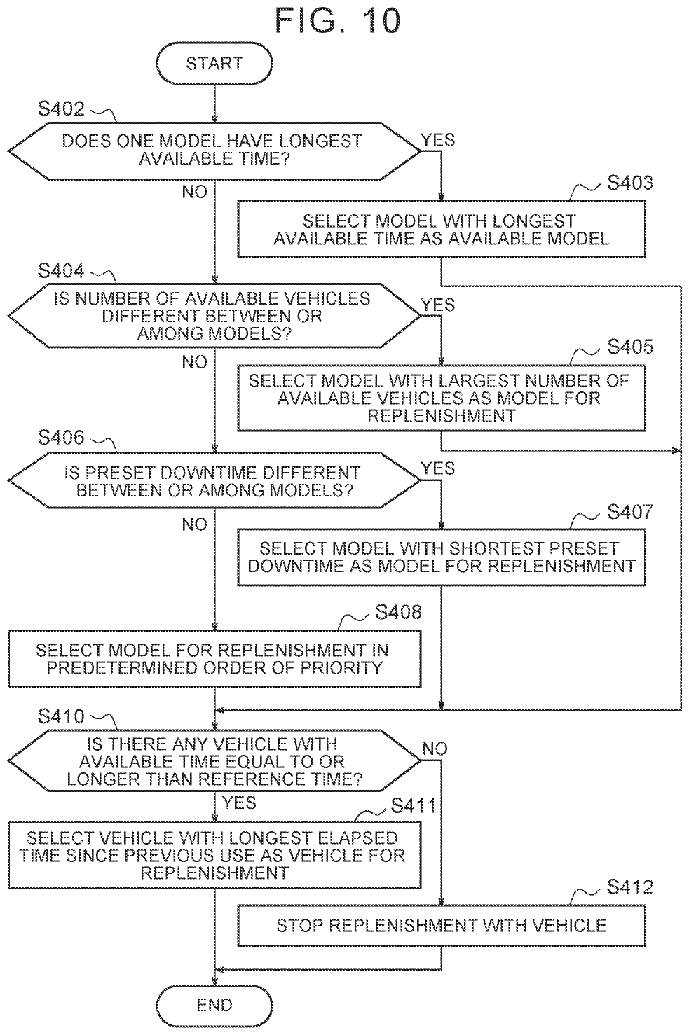

FIG. 10 is a flowchart showing a detailed procedure of step S304 of FIG. 9. When one model has the longest available time (Yes in step S402), the control unit 15 selects that model as the available model (step S403). In the example of FIG. 11, since the available time of model A is 72 hours and the available time of model B is 24 hours, the control unit 15 selects model A as the available model. Referring back to FIG. 10, the control unit 15 then proceeds to step S410.

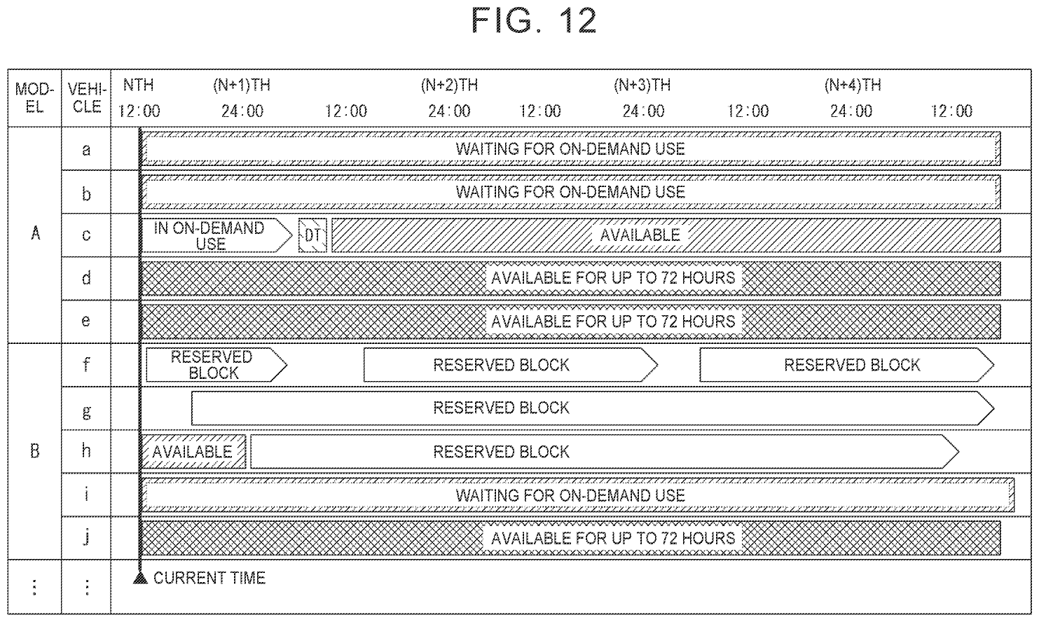

When more than one model has the longest available time (No in step S402), the control unit 15 determines whether the number of available vehicles 30 is different between or among the models having the longest available time (step S404). When the number of available vehicles 30 is different between or among the models having the longest available time (Yes in step S404), the control unit 15 selects the model with the largest number of available vehicles 30 as the available model (step S405). This reduces the risk that immediately after replenishment with a vehicle 30 was made for on-demand use, a reservation is made for the model of that vehicle 30 and the reservation cannot be accepted. For example, a reservation table shown in FIG. 12 is different from the reservation table shown in FIG. 11 in that the available time of the vehicle j of model B is 72 hours. In the reservation table of FIG. 12, the available time is 72 hours for both models A and B. Two vehicles d, e of model A and one vehicle j of model B are currently available. Since the number of available vehicles of model A is larger than the number of available vehicles of model B, the control unit 15 selects model A as the available model. The control unit 15 then proceeds to step S410 in FIG. 10.

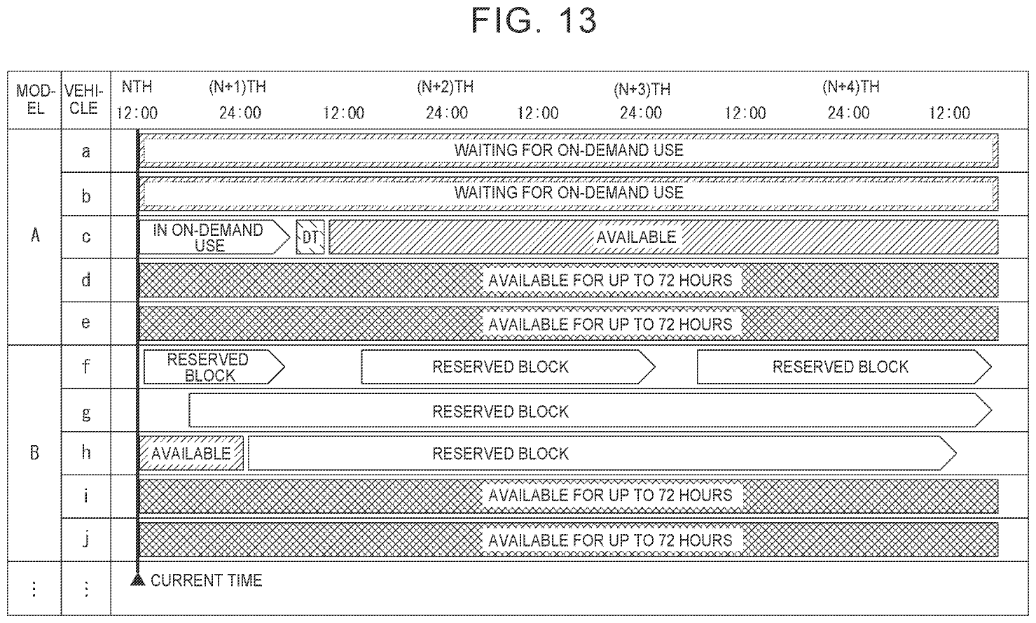

When the numbers of available vehicles 30 of a plurality of models are the same (No in step S404), the control unit 15 determines whether the preset downtime is different between or among the models (step S406). When the preset downtime is different between or among the models (Yes in step S406), the control unit 15 selects the model with the shortest preset downtime as the available model (step S407). It is probable that the replenished model has a high utilization rate. The utilization rate of that model can be maximized by replenishing with the model having a short preset downtime. For example, a reservation table shown in FIG. 13 is different from the reservation table shown in FIG. 12 in that the available time of the vehicle i of model B is 72 hours. In the reservation table of FIG. 13, the available time is 72 hours for both models A and B, and two vehicles d, e of model A and two vehicle i, j of model B are currently available. Assuming that the preset downtime of model A is 3 hours and the preset downtime of model B is 1 hour, the control unit 15 selects model B with a shorter preset downtime as the available model. The control unit 15 then proceeds to step S410 in FIG. 10.

When the preset downtime is the same between or among the models (No in step S406), the control unit 15 selects the available model in order of priority set as desired in advance (step S408). The control unit 15 then proceeds to step S410 in FIG. 10.

When there is any vehicle 30 of the selected model that has an available time equal to or longer than a reference time (Yes in step S410), the control unit 15 selects the vehicle 30 with the longest elapsed time since the previous use as the vehicle 30 for replenishment from the vehicles 30 with an available time equal to or longer than the reference time (step S411). The control unit 15 thus ends the procedure of FIG. 10. The reference time is the amount of time during which the use of the vehicle 30 is expected to occur with a certain degree of probability. The reference time is set as desired and is about one to three hours. For example, the reference time is two hours.

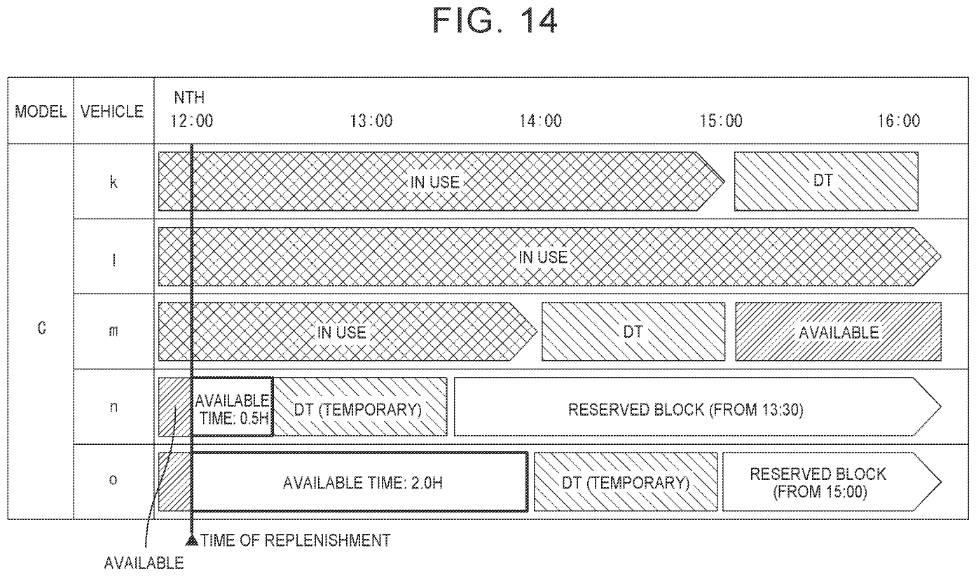

FIG. 14 shows an example of a reservation table for model C. This reservation table shows the reservation status of five vehicles 30 of model C, that is, the reservation status of vehicles k, l, m, n, and o. In this reservation table, the abscissa represents time. Of the vehicles 30, the available times of the vehicles n, o are 0.5 hours and 2.0 hours, respectively. For example, when model C is selected as the available model, the control unit 15 selects the vehicle o with an available time equal to or longer than the reference time, namely equal to or longer than two hours, as the vehicle 30 for replenishment. If there is any vehicle 30 of model C other than the vehicle o that has an available time equal to or longer than two hours, the control unit 15 selects the vehicle 30 with the longest elapsed time since the previous use as the vehicle 30 for replenishment. This equalizes the utilization rates among the vehicles 30 and wear due to operation load among the vehicles 30.

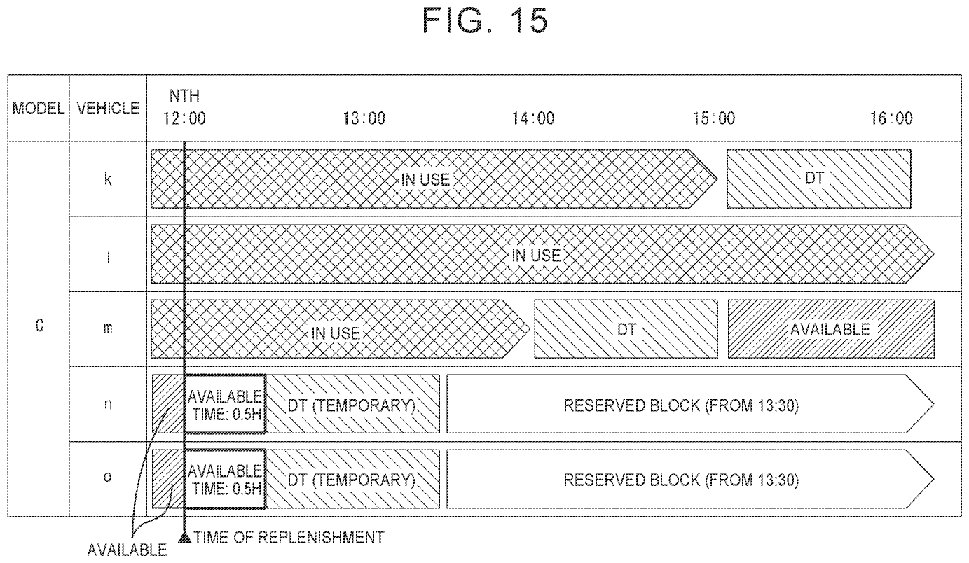

Referring back to FIG. 10, when no vehicle 30 has an available time equal to or longer than the reference time (No in step S410), the control unit 15 stops replenishment with a vehicle 30 for on-demand use (step S412), and ends the procedure of FIG. 10. For example, a reservation table shown in FIG. 15 is different from the reservation table shown in FIG. 14 in that the available time of the vehicle o is 0.5 hours. In the reservation table of FIG. 15, no vehicle 30 has an available time equal to or longer than two hours. Accordingly, the control unit 15 stops replenishment with a vehicle 30 for on-demand use.

When the vehicle 30 waits for on-demand use, the vehicle 30 needs to wait for a period of time during which the use of the vehicle 30 is expected to occur with a certain degree of probability. This is because replenishment may otherwise become a waste. Since replenishment is stopped when there is no vehicle 30 having an available time equal to or longer than the reference time, the risk of such a waste is reduced. When the replenishment is stopped, replenishment is not made with a vehicle 30 from the parking area 2 for which the procedure of FIG. 10 is performed.

Referring back to FIG. 9, when the available model and the vehicle 30 for replenishment are selected as a result of step S304 (Yes in step S306), the control unit 15 sends a replenishment command to the selected vehicle 30 for replenishment (step S310). The replenishment command is a command to move the vehicle 30 for replenishment to the on-demand waiting area 203 that is short of a vehicle 30. The replenishment command includes information identifying the vehicle 30 for replenishment, information identifying the on-demand waiting area 203, information on the point in the on-demand waiting area 203 where the vehicle 30 for replenishment is supposed to wait, etc. The vehicle 30 having received the replenishment command moves to the on-demand waiting area 203 in response to the replenishment command.

When the available model and the vehicle 30 for replenishment are not selected (No in step S306), the control unit 15 determines whether steps S302 and S304 have been performed for the other parking areas (step S307). When steps S302 and S304 have not been performed for the other parking areas (No in step S307), the control unit 15 switches the parking area 2 for which steps S302 and S304 are to be performed to one of these parking areas 2 (step S308), and steps S302 and S304 are performed for that parking area 2. When the available model and the vehicle 30 for replenishment are selected for another parking area 2 as a result of step S304 (Yes in step S306), the control unit 15 sends a replenishment command to the selected vehicle 30 for replenishment (step S310). The on-demand waiting area 203 is thus replenished with a vehicle 30, and the risk of the opportunity cost is minimized. When the available model and the vehicle 30 for replenishment are not selected for any of the parking areas 2 (Yes in step S307), the control unit 15 ends the procedure of FIG. 9. In that case, the on-demand waiting areas 203 are not replenished with a vehicle 30.

Even when the on-demand waiting areas 203 are not replenished with a vehicle 30, the control unit 15 of the information processing device 10 performs the procedure of FIG. 9, for example, at desired intervals (e.g., at intervals of several minutes to several tens of minutes) or every time the vehicle 30 returns to the backyard 201. The on-demand waiting area 203 can thus be replenished with a vehicle 30 as soon as there is a vehicle 30 in the backyard 201 that satisfies a condition for replenishment.

As described above, in the information processing device 10 of the present embodiment, the control unit 15 acquires the request information for the use of the vehicle 30 from the user either as request information for reservation use or request information for on-demand use. Even when the on-demand waiting area 203 becomes short of a certain model or short of a vehicle 30, the information processing device 10 can replenish the on-demand waiting area 203 with the model or a vehicle 30 from the backyard 201 while not hindering reservation use. It is therefore possible to improve the efficiency of management of the vehicles 30 for on-demand use.

The present disclosure is not limited to the above embodiment. For example, a plurality of blocks shown in the block diagram may be integrated into one block, or a block may be divided into a plurality of sub-blocks. Instead of performing a plurality of steps of the flowchart in chronological order according to the description, the steps may be performed in parallel or in a different order either according to the processing capability of the device that performs each step or as necessary. Other modifications can be made without departing from the spirit and scope of the present disclosure.

For example, a part of the processing operation performed by the information processing device 10 in the above embodiment may be performed by the terminal device 20.

For example, a part of the processing operation performed by the terminal device 20 in the above embodiment may be performed by the information processing device 10.

For example, a general-purpose electronic device such as smartphone or computer may be configured to function as the information processing device 10 of the above embodiment. Specifically, programs including the processing content for implementing each function of the information processing device 10 etc. of the embodiment are stored in a memory of the electronic device, and the programs are read and executed by a processor of the electronic device. Accordingly, the disclosure in the embodiment can also be implemented as a program that can be executed by a processor.

Although an example in which a plurality of models of vehicles 30 is available for the car sharing service is described in the above embodiment, the number of models of vehicles 30 may be one.

What is claimed is:

1. An information processing device comprising a controller configured to:
send information to another device;
receive information from the other device;
select an available model based on a reservation status for each model of vehicles stored at a first storage location, the available model being a model with a longer available time than other models; and
send, to a first vehicle corresponding to the available model, a command to move to an on-demand waiting area.

2. The information processing device according to claim 1, wherein the controller is configured to select the available model on an additional condition that the number of vehicles about a model stored at the first storage location is larger than the number of vehicles about the other models stored at the first storage location.

3. The information processing device according to claim 1, wherein the controller is configured to select the available model on an additional condition that a preset downtime of the available model necessary to prepare for use is shorter than preset downtimes of the other models.

4. The information processing device according to claim 1, wherein the controller is configured to select the available model in predetermined order of priority.

5. The information processing device according to claim 1, wherein the controller is configured to select the first vehicle on an additional condition that an available time of the first vehicle is equal to or longer than a reference time.

6. The information processing device according to claim 5, wherein the controller is configured to select the first vehicle on an additional condition that elapsed time since previous use of the first vehicle is longer than elapsed times since previous use of other vehicles corresponding to the available model.

7. The information processing device according to claim 5, wherein the controller is configured to, when the controller does not select the first vehicle, send the command to a second vehicle instead of the first vehicle, the second vehicle being a vehicle that is stored at a second storage location and belongs to the available model and elapsed time since previous use of the second vehicle being equal to or longer than the reference time.

8. The information processing device according to claim 7, wherein the controller is configured to stop sending the command when the controller does not select the second vehicle.

9. The information processing device according to claim 8, wherein the controller is configured to perform a process of sending the command to the first vehicle corresponding to the available model by selecting the available model stored at the first storage location at a predetermined timing after stopping sending the command.

10. The information processing device according to claim 1, further comprising a transmitter, wherein the controller is configured to:
send information to the other device via the transmitter; and
receive information from the other device via the transmitter.

11. A non-transitory storage medium storing instructions that are executable by one or more processors in an information processing device, and that cause the one or more processors in the information processing device to perform functions comprising:
sending information to another device;
receiving information from the other device;
selecting an available model based on a reservation status for each model of vehicles stored at a first storage location, the available model being a model with a longer available time than other models; and
sending, to a first vehicle corresponding the available model, a command to move to an on-demand waiting area.

12. An operation method for an information processing device including a controller configured to send information to another device and receive information from the other device, the operation method comprising:
selecting an available model by the controller based on a reservation status for each model of a plurality of vehicles stored at a first storage location, the available model being a model with a longer available time than other models; and
sending, to a first vehicle corresponding to the available model, a command from the controller to move to an on-demand waiting area.

13. The operation method according to claim 12, further comprising selecting the available model by the controller on an additional condition that the number of vehicles about a model stored at the first storage location is larger than the number of vehicles about the other models stored at the first storage location.

14. The operation method according to claim 12, further comprising selecting the available model by the controller on an additional condition that a preset downtime of the available model necessary to prepare for use is shorter than preset downtimes of the other models.

15. The operation method according to claim 12, further comprising selecting the available model by the controller in predetermined order of priority.

16. The operation method according to claim 12, further comprising selecting the first vehicle by the controller on an additional condition that an available time of the first vehicle is equal to or longer than a reference time.

17. The operation method according to claim 16, further comprising selecting the first vehicle by the controller on an additional condition that elapsed time since previous use of the first vehicle is longer than elapsed times since previous use of other vehicles corresponding to the available model.

18. The operation method according to claim 17, further comprising when the first vehicle is not selected by the controller, sending the command from the controller to a second vehicle instead of the first vehicle, the second vehicle being a vehicle that is stored at a second storage location and belongs to the available model and elapsed time since previous use of the second vehicle being equal to or longer than the reference time.

19. The operation method according to claim 18, further comprising stopping sending the command from the controller when the second vehicle is not selected by the controller.

20. The operation method according to claim 19, further comprising performing a process of sending the command from the controller to the first vehicle corresponding to the available model by selecting the available model stored at the first storage location at a predetermined timing after stopping sending the command.
